(19) United States
(12) Patent Application Publication
(10) Pub. No.: US 2024/0070552 A1
(43) Pub. Date: Feb. 29, 2024

(54) METHODS AND SYSTEMS FOR DETERMINING PAYMENT BEHAVIOURS

(71) Applicant: Xero Limited, Te Aro, Wellington (NZ)

(72) Inventors: Martin Kemka, Te Aro, Wellington (NZ); Donald Permezel, Te Aro, Wellington (NZ)

(21) Appl. No.: 18/028,438

(22) PCT Filed: Aug. 25, 2021
(86) PCT No.: PCT/NZ2021/050149

§ 371 Date: Mar. 24, 2023

(30) Foreign Application Priority Data
May 21, 2021 (AU) 2021901523

(51) Int. Cl. G06N 20/20; G06Q 40/12

(52) U.S. Cl. CPC G06N 20/20; G06Q 40/12

(57) ABSTRACT

Described is determining a dataset of historical financial record data related to an entity set comprising one or more entities having a common attribute, the historical financial record data comprising an actual payment date or an indication of voiding for each of a plurality of invoices associated with one or more entities of the entity set. Also described is determining a first model of payment behavior of the entity set configured to predict a date of payment of an invoice by an entity.

### TECHNICAL FIELD

Embodiments generally relate to methods, systems, and computer-readable media for determining payment behaviour of entities. In some embodiments, the payment behaviour of entities may be based on financial records, which may relate to records of payment obligations, such as records relating to invoices or bills.

### BACKGROUND

Financial records relating to transactions of a business may include significant information to assist financial planning, financial forecasting, or cash flow predictions for businesses. However, financial records may be generated at a significant pace and it is often difficult for a business to have complete and sufficient oversight of the financial records to readily derive actionable insights.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

### SUMMARY

Some embodiments relate to a method comprising: determining a dataset of historical financial record data related to an entity set, the entity set comprising one or more entities having a common attribute, and wherein the historical financial record data comprises an actual payment date or an indication of voiding for each of a plurality of invoices associated with one or more entities of the entity set; determining a first model of payment behaviour of the entity set, the first model configured to predict a date of payment of an invoice by an entity; determining a second model of payment behaviour of the entity set, the second model configured to predict a date of payment of an invoice by the entity, and the second model being different to the first model; determining a first predicted payment date for each of the plurality of invoices associated with the dataset of historical financial record data using the first model; determining a second predicted payment date for each of the plurality of invoices associated with the dataset of historical financial record data using the second model; determining a first error metric associated with the first model, wherein the first error metric is based on a first difference measure between the actual payment date and the predicted first payment date for each of the plurality of invoices; determining a second error metric associated with the second model, wherein the second error metric is based on a second difference measure between the actual payment date and the predicted second payment date for each of the plurality of invoices; selecting a designated prediction model from a set of prediction models based on corresponding error metrics of the respective prediction models, the set comprising at least the first model and the second model; and deploying the designated prediction model for predicting payment behaviour for the entity set.

The plurality of invoices may be invoices issued by (i) a particular issuing entity or (ii) a group of issuing entities having a common attribute. Each of the plurality of invoices may be associated with a same first entity as an invoice addressee.

In some embodiments, at least the first model of the first and second models is a univariate model, and wherein the dataset of historical financial record data further comprises an issue date and/or a due date of each of the plurality of invoices associated with the dataset. The univariate model may predict invoice payment dates for the first entity as being any one of: (i) a particular number of days after the issue date or the due date; (ii) a particular date of the month of the issue date or due date; (iii) a next day of the week after the issue date or due date; (iv) a next business day of the week after the issue date or the due date; (v) a predefined day of a predefined week of a month after the issue date or the due date; and (vi) a specific number of days after the issue date or the due date.

In some embodiments, the at least the second model is a multivariate model, and the method further comprises: determining values for a plurality of first feature for each of the respective plurality of invoices associated with the dataset; and providing, as an input to the multivariate model, the values of the plurality of first feature associated with the plurality of invoices; and predicting, as an output, the second payment date for the plurality of invoices.

The second model may comprise a first sub model configured to predict an invoice payment date for an invoice that is not overdue. The model may comprise a second sub model configured to predict an invoice payment date for an invoice that is overdue. The first features provided to the first sub model may be different to, or the same as, the first features provided to the second sub model. The values for the plurality of first features may be derived from the respective invoice and/or accounting information associated with an entity addressee of the respective invoice. The multivariate model may be implemented using a random forest regression model.

In some embodiments, the method may further comprise: determining a third model of payment behaviour of the entity set, the third model configured to predict a probability of non-payment of an invoice associated with the entity set; and determining a probability score of non-payment of each of the plurality of invoices associated with the dataset of historical financial record data using the third model; determining a third error metric associated with the third model, wherein the third error metric is indicative of the accuracy of the probability score relative to whether or not the invoice was paid; and wherein the set of prediction models from which the designated prediction model is selected comprises the third model.

The method may further comprise determining values for a plurality of second features for each of the respective plurality of invoices associated with the dataset; and providing, as an input to the multivariate model, the values of the plurality of second features associated with the plurality of invoices; and predicting, as an output, the probability score of non-payment of each of the plurality of invoices. The values for the plurality of second features may be derived from the respective invoice and/or accounting information associated with an entity addressee of the respective invoice. The third model may be implemented using logistic regression or a random forest classifier.

Some embodiments relate to a method comprising: determining a dataset of historical financial record data related to an entity set, the entity set comprising one or more entities having a common attribute, and wherein the dataset of historical financial record data comprises an actual payment date or an indication of voiding for each of a plurality of invoices associated with one or more entities of the entity set; determining a first model of invoice payment behaviour of the entity set, the first model configured to predict a date of payment of an invoice by an entity; determining a second model of invoice payment behaviour of the entity set, the second model configured to predict a probability of non-payment of the invoice by the entity; determining a first predicted payment date for each of the plurality of invoices associated with the dataset of historical financial record data using the first model; determining a probability score of non-payment of each of the plurality of invoices associated with the dataset of historical financial record data using the second model; determining a first error metric associated with the first model, wherein the first error metric is based on a first difference measure between the actual invoice payment date and the predicted first payment date for each of the plurality of invoices; determining a second error metric associated with the second model, wherein the second error metric is indicative of the accuracy of the probability score relative to whether or not the invoice was paid; selecting a designated prediction model from a set of prediction models based on corresponding error metrics of the respective prediction models, the set comprising at least the first model and the second model; and deploying the designated prediction model for predicting payment behaviour for the entity set.

The method may further comprise receiving invoice data relating to a candidate invoice, the invoice data comprising a first entity identifier; determining the designated invoice prediction model based on the entity identifier; providing the invoice data of the candidate invoice to the designated invoice prediction model to predict a payment date of the candidate invoice; and outputting, by the designated invoice prediction model, a predicted payment date for the candidate invoice.

The method may further comprise determining account information associated with the first entity identifier; and providing the determined account information to the designated invoice prediction model to predict the payment date of the candidate invoice.

Some embodiments relate to a method comprising: providing, to a computing device, a user interface, the user interface comprising a user selectable option for determining a predicted payment date or non payment of a particular invoice associated with an entity identifier; determining user selection of the user selectable option; determining a designated prediction model for predicting payment behaviour for the entity identifier; determining values of features for inputting to the designated prediction model; providing the determined values to the designated prediction model to determine, the predicted payment date or expected non-payment of the invoice; providing an output to the user interface, wherein the output is based on the predicted payment date or expected non-payment of the invoice.

In some embodiments, determining the designated prediction model for predicting payment behaviour for the entity identifier may be performed according to any one of the described embodiments.

Some embodiments relate to a computing device comprising: one or more processors; and memory comprising computer executable instructions, which when executed by the one or more processors, cause the system to perform any one of the described methods.

Some embodiments relate to a computer-readable storage medium storing instructions that, when executed by a computer, cause the computer to perform any one of the described methods.

### BRIEF DESCRIPTION OF DRAWINGS

FIG. 1 is a block diagram of a system for financial record analysis, according to some embodiments;

FIG. 2 is a process flow diagram of a method of determining payment behaviour of an entity, according to some embodiments;

FIG. 3 is a process flow diagram of a method of determining payment behaviour of an entity, according to some embodiments;

FIG. 4 is a process flow diagram of a method of determining a predicted payment date for a candidate invoice, according to some embodiments; and

FIGS. 5 to 11a and 11b illustrate charts of various error values determined for described embodiments of models used in the method of FIG. 2, according to some embodiments.

### DESCRIPTION OF EMBODIMENTS

Embodiments generally relate to methods, systems, and computer-readable media for determining payment behaviour of entities based on financial records. In some embodiments, the financial records may relate to records of payment obligations, such as records relating to invoices or bills.

Payment behaviour of entities may be challenging to predict as different entities may follow distinct, and potentially dynamic, patterns in payment of invoices depending on their circumstances. For example, some entities may make payments of invoices in response to certain recurring events, such as receipt of a recurring payment to their bank account. However, being able to predict when or if invoices will be paid can be beneficial to businesses, particularly in assisting them to manage cash flow, providing insight into when short term credit might be required and/or surplus cash might be invested, for example.

Described embodiments provide for improved techniques for financial document analysis to more accurately predict payment behaviour of an invoice addressee of a candidate invoice. Some entities have relatively predictable payment behaviour and tend to follow relatively predictable patterns of behaviour, such as paying invoices on the last day of the month, on the issue date, or on the next business day after the due date, for example. Such payment behaviour may be modelled by relatively straightforward mathematical models, such as univariate models. The univariate model may be provided with a variable extracted from the candidate invoice, such as the due date, and make a prediction as to when the candidate invoice will be paid.

Other entities may appear to exhibit more complex payment behaviour, and may be better modelled using a multivariate model. The multivariate model may consider features extracted from the candidate invoice, such as due date or amount, but may also consider various metrics based on the financial information of the entity, such as a number of currently outstanding invoices, how many invoices were received in the past month, an account balance of the entity, etc. The multivariate model may make a prediction as to when the candidate invoice will be paid.

Some entities exhibit patterns of not paying invoices within particular periods of time, such as within the payment term, within a fixed period after the payment term, or indeed at all. Such behaviour may also be modelled using a multivariate model, with the output being an indication of the probability of the entity paying the invoice, potentially within a given period of time. The multivariate model for determining the probability of non-payment of an invoice may consider features extracted from the candidate invoice, such as due date or amount, but may also consider various metrics based on the financial information of the entity, such as a total amount of voided invoices, a number of voided invoice, a number of paid invoices, etc.

By electing a most suitable model for predicting payment behaviour of an invoice addressee of a candidate invoice, a more accurate prediction of when, or if, that candidate invoice will be paid can be achieved. To this end, described embodiments relate to configuring these models and testing them based on, or fitting them to, a dataset of historical financial data associated with an entity set comprising one or more entities having a common attribute. The historical financial record data comprises an actual payment date attribute or an indication of voiding for each of a plurality of invoices associated with one or more entities of the entity set. Where no value for the actual payment date attribute is provided, or the value is null or zero for example, it is understood that no payment has been made. In some embodiments, the historical financial record data comprises a paid attribute for each of the plurality of invoices, the paid attribute indicative of whether or not the invoice has been paid, for example, within a given time period.

In some embodiments, the entity set may comprise historical financial record data associated with a single invoice addressee only, and a single invoice issuer. In this way, the payment behaviour of a particular entity with respect to a particular invoice issuer may be modelled or predicted by the plurality of models. In some embodiments, the entity set may comprise historical financial record data associated with a single invoice addressee only, and multiple different invoice issuers, allowing for the payment behaviour of the invoice address across a plurality of their creditors. In some embodiments, the entity set may comprise historical financial record data associated with a plurality of invoices addressees and/or invoice issuers, where each of the entities of the entity set have one or more common attributes. For example, invoices addressees and/or invoice issuers may be associated with a similar business type, business stage, typical revenue, geography/location etc. Accordingly it may be possible to model or predict payment behaviours of a group or genre as a whole, such as typical payment behaviours of suppliers in the hospitality industry.

To predict when or if a candidate invoice will be paid, one or more attributes of the candidate invoice (such as entity identifier and/or business type for example) are identified. In some embodiments, the one or more attributes of the candidate invoice are used to determine a suitable database of historical financial records on which to base the potential prediction models. At least two different models are selected and evaluated based on the database of historical financial records. An error metric is determined for each of the at least two different models. The error metric is indicative of the suitability of the respective model in accurately predicting invoice payment behaviour. The model with the lower error metric may be selected and deployed for predicting payment behaviour of the entity. In some embodiments, designated models for different entity sets, or for specific entities and/or issuer(s) may be determined in advance of receiving candidate invoices, as opposed to being determined on the fly.

The historical financial record data associated with one or more attributes, such as a particular entity or class of entities, may be updated dynamically to include new data of relevant financial records. For example, once an invoice is paid, or a period of time has expired without the invoice being paid (in which case it may be deemed void), data associated with the invoice may be added to the historical financial record data.

Of course, the payment behaviour of an entity may change over time, for example, depending on cash flow, which may of course be impacted by a change in seasons, increased expenditure and/or reduced sales, etc. Accordingly, as new data is added to the historical financial record data, the most suitable model for predicting payment behaviour based on the historical financial record data may deviate from a previously elected model. Accordingly, in some embodiments, the determination and designation of a most suitable model for a particular entity set may be re-performed, which may result in a different model being deployed to predict payment behaviour of the entity set. In some embodiments, the determination of a suitable model may be performed periodically, for example, monthly, or may be performed once a threshold number of new invoices have been processed and the related data added to the historical financial record data for the entity set. In this way, if the payment behaviour of an entity set changes over time, a more suitable model may be determined and deployed to better predict payment behaviour of the entity set, mitigating impacts of the changing payment behaviour of entities associated with the entity set on predicted payment behaviours associated with entities of candidate invoices.

Training or configuring multiple models and choosing one with a lower error rate allows incorporation and consideration of alternative modelling techniques for predicting payment behaviour of entities. As the payment behaviour of entities may significantly vary, selection or election of a model with a lowest error metric allows for an improved prediction of the payment behaviour of the entity associated with the candidate invoice.

In some embodiments, the invoice payment behaviour may be presented in the form of a number of days after a candidate invoice issue date or an invoice due date or a current date that a payment may be expected. In some embodiments, the invoice payment behaviour may be presented in the form of a date on which payment of a candidate invoice may be expected. The number of days to payment, or expected date of payment information may be useful in estimating future cash flow of an invoice issuing entity and accordingly performing the practical application of financial planning. In some embodiments, the predicted payment behaviour may be represented in a financial report generated by an accounting system. In some embodiments, the predicted payment behaviour may be represented in a graph or a chart of a cash flow forecast of an invoice issuing entity generated by an accounting system.

In some embodiments, the invoice predictor behaviour may relate to the invoice payment behaviours of a class of entities associated with a common identifier. For example, a class of entities may include a class of utilities consumers and the predicted invoice payment behaviour may relate to the payment behaviour of the class of utilities consumers and their respective utilities related invoice payment behaviours. Accordingly, some embodiments may allow prediction of payment behaviour across a class or group of entities with a common class or group identifier.

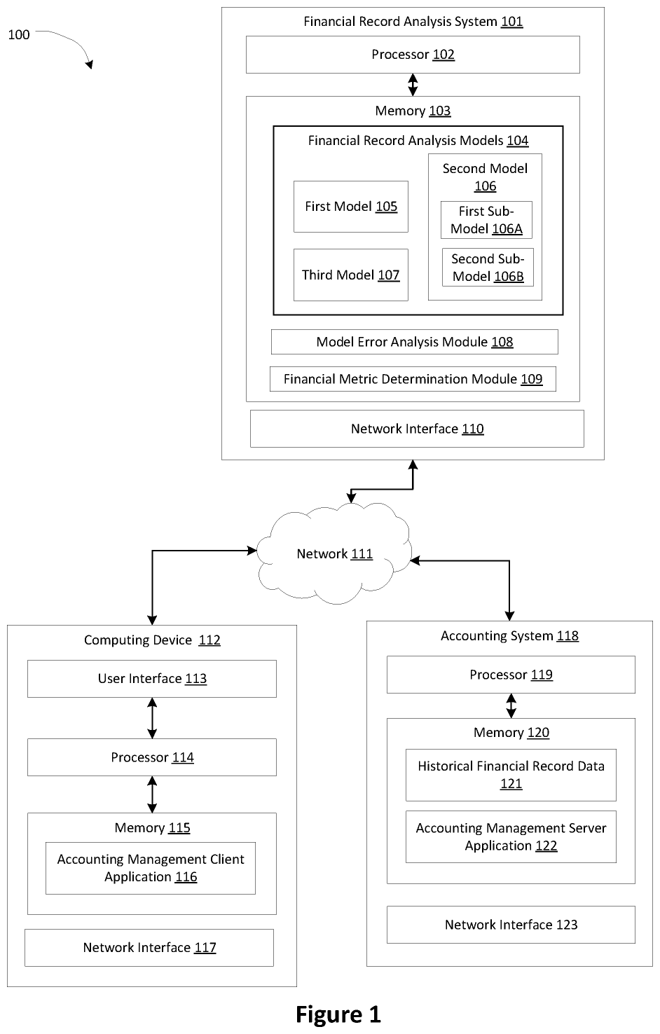

FIG. 1 is a block diagram of a system 100 for financial record analysis, according to some embodiments. System 100 comprises a financial record analysis system 101 in communication with an accounting system 118 and a computing device 112.

The financial record analysis system 101 comprises at least one processor 102 in communication with a memory 103. Memory 103 comprises program code, program code libraries, program code dependencies, application programming interfaces, metadata and configuration data which are executable by the processor(s) 102 to process financial records, provide functionality to one or more computing device 112, communicate with the accounting system 118 and/or to function according to the described methods. The processor(s) 102 may comprise one or more microprocessors, central processing units (CPUs), application specific instruction set processors (ASIPs), application specific integrated circuits (ASICs) or other processors capable of fetching and executing instruction code.

Memory 103 may comprise one or more volatile or non-volatile memory types. For example, memory 103 may comprise one or more of random access memory (RAM), read-only memory (ROM), electrically erasable programmable read-only memory (EEPROM) or flash memory. Memory 103 is configured to store program code accessible by the processor(s) 102. The program code comprises executable program code modules. In other words, memory 103 is configured to store executable code modules configured to be executable by the processor(s) 102. The executable code modules, when executed by the processor(s) 102 cause the system 101 to perform certain functionality, as described in more detail below.

Memory 103 comprises a plurality of financial record analysis models 104. In some embodiments, the financial record analysis models 104 may comprise a first model 105, a second model 106 and/or a third model 107. The first and/or second models 105, 106, may comprise one or more univariate models. The first, second and/or third models 105, 106, 107 may comprise one or more multivariate models. The first and second models 105, 106 may be configured to predict a date of payment of a candidate invoice. The third model 107 may be a non-payment estimation model configured to predict a probability of non-payment or voiding of a candidate invoice. Each model 105, 106, 107 may comprise program code implementing mathematical, statistical or machine learning operations or logic defined or configured based on financial record data. Each model 105, 106, 107 may generate inferences regarding invoice payment behaviour based on data relating to a candidate invoice. Each model 105, 106, 107 may perform analysis of data relating to a candidate invoice based on one or more variables or attributes associated with the candidate invoice.

In some embodiments, the first model 105, the second model 106, and/or the third model 107 may model the payment behaviour of a group of entities with a common identifier. In some embodiments, the first model 105, the second model 106, and/or the third model 107 may model the payment behaviour of an invoice addressee or a transaction counterparty (first entity). In some embodiments, the first model 105 and the second model 106 may produce as an output, a number of days after an invoice issue date that the invoice is most likely expected to be paid by the invoice addressee (first entity). In some embodiments, the first model 105 and the second model 106 may produce, as an output, a number of days before or after an invoice due date that the invoice is most likely expected to be paid by the invoice addressee.

In some embodiments, the model(s) 105, 106, 107 may use one or more libraries, such as Python libraries dateutil, numpy and/or Calendar to generate a relative day based on the predicted value determined by the model(s). In some embodiments, payment date patterns, such as calendar day or date of the month, business days, non-business days, and/or specific days or dates of the month (such as the 1^{st} Monday of the month, or the 2nd Friday of the month) may be encoded as numbers. For example, by assigning the first Sunday of a month as “0” and incrementing each day from there, the 1st Wednesdays of every month would be assigned a “3”, or the 2nd Friday of every month would be a “12”.

Memory 103 further comprises a model error analysis module 108. The model error analysis module 108 comprises program code to analyse the financial record analysis models 104 and determine an error rate or an error metric associated with each respective analysed model. The error rate or error metric may allow comparison between the models to select a model that has a lower error rate.

Memory 103 further comprises a financial metric determination module 109. The financial metric determination module 109 comprises program code to analyse or process financial data and generate one or more metrics used as an input to any of the financial record analysis models 104. Suitable metrics are identified below.

The system 101 further comprises a network interface 102 to facilitate communications with components of the system 100 across the communications network 111, such as the computing device 112, and/or accounting system 118. The network interface 110 may comprise a combination of network interface hardware and network interface software suitable for establishing, maintaining and facilitating communication over a relevant communication channel.

The network 111 may include, for example, at least a portion of one or more networks having one or more nodes that transmit, receive, forward, generate, buffer, store, route, switch, process, or a combination thereof, etc. one or more messages, packets, signals, some combination thereof, or so forth. The network 111 may include, for example, one or more of: a wireless network, a wired network, an internet, an intranet, a public network, a packet-switched network, a circuit-switched network, an ad hoc network, an infrastructure network, a public-switched telephone network (PSTN), a cable network, a cellular network, a satellite network, a fibre-optic network, some combination thereof, or so forth.

The computing device 112 comprises a user interface 113 whereby one or more user(s) can submit requests to the computing device 112, and whereby the computing device 112 can provide output to the user. The user interface 113 may comprise one or more user interface components, such as one or more of a display device, a touch screen display, a keyboard, a mouse, a camera, a microphone, buttons, for example.

The computing device 112 comprises at least one processor 114 in communication with a memory 115 and the user interface 113. Memory 115 may comprise program code to implement an accounting management client application 116. The accounting management client application 116 may provide functionality to an end user to interface with financial records in the accounting system 118 and the financial record analysis system 101. The accounting management client application 116 may allow a user to send requests or instructions to the accounting system 118 or the financial record analysis system 101 and receive results or output based on the requests. The accounting management client application 116 may be an application accessible through an internet browser or in embodiments where the computing device 112 is a smart phone, the accounting management client application 116 may be implemented as a smartphone application such as an Android™ or an iPhone™ application, for example.

The computing device 112 further comprises a network interface 117 to facilitate communications with components of the system 100 across the communications network 111, such as the financial record analysis system 101, and/or accounting system 118. The network interface 117 may comprise a combination of network interface hardware and network interface software suitable for establishing, maintaining and facilitating communication over a relevant communication channel.

The accounting system 118 comprises at least one processor 119 in communication with memory 120. Memory 120 comprises code modules to implement an accounting management server application 122. The accounting management server application 122 provides accounting records management capability to users of computing device 112 and may comprise various submodules to manage, create and reconcile accounting data, or analyse the accounting data to make inferences based on the accounting data. In some embodiments, the accounting management server application 122 may be a cloud-based accounting system such as a cloud-based accounting system provided by Xero™. In some embodiments, one or more of the first model 105, the second model 106, and/or the third model 107 may be deployed or executed by the accounting management server application 122 in response to a request from the computing device 112. An output produced by one or more of the first model 105, the second model 106, and/or the third model 107 may be presented though user interface 113, for example, in response to an execution of one or more of the first model 105, the second model 106, and/or the third model 107 by the accounting management server application 122.

Memory 120 also comprises historical financial record data 121. In some embodiments, the historical financial record data 121 may relate to historical invoice record data. The historical invoice record data may comprise one or more attributes associated with an invoice including an invoice issue date, an invoice due date, an invoice payment date, an invoice amount, for example. The attributes associated with an invoice may include: an invoice date or an invoice issue date, an invoice amount, an invoice issuer entity identifier, an invoice addressee or counterparty entity identifier, an invoice due date, an invoice terms data, an invoice settlement or payment date data, for example. The data relating to invoice in the historical financial record data 121 may be created and updated as an invoice is created by a computing device 112 and transmitted to the invoice addressee, and subsequently when reconciliation of the invoice occurs by the computing device 112 in response to one or more payments by the invoice addressee, for example.

In some embodiments, the various code modules of the financial record analysis system 101 may be a part of the accounting system 118. In some embodiments, one or more models within the financial record analysis models 104 may be deployed in memory 120 of the accounting system 120 to provide functionality to the computing device 112 through the accounting management server application 122.

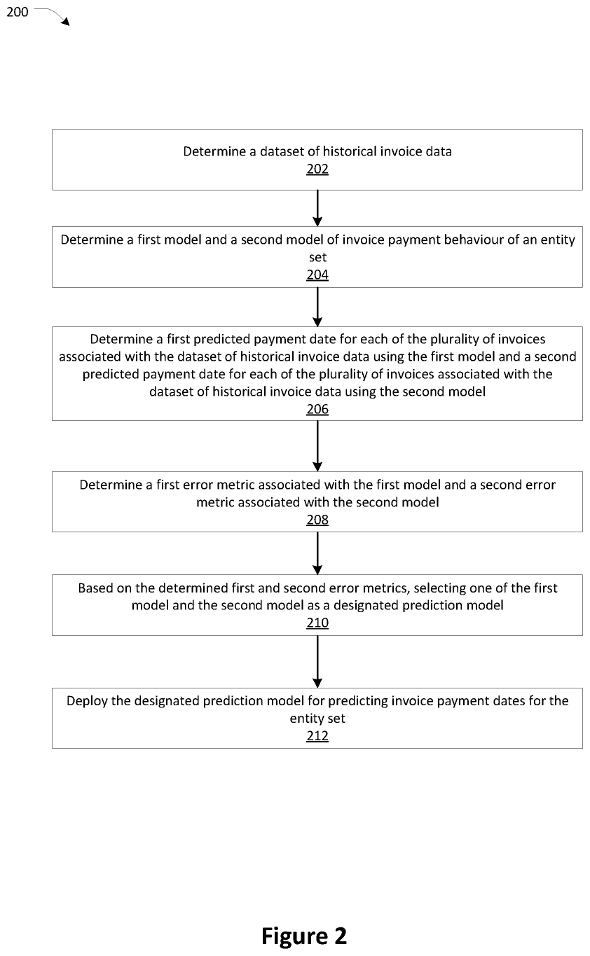

FIG. 2 is a process flow diagram of a method 200 of determining payment behaviour of a set of entities (entity set) associated with at least one common attribute, according to some embodiments. For example, the common attribute(s) may be a business stage (such as a start-up business), a business type (such as an electricity provider), a typical turnover, and/or location of the entity. In some embodiments, the set of entities comprises a single entity. The method 200 may, for example, be implemented by the processor(s) 102 of the financial record analysis system 101 executing instructions stored in memory 103.

At 202, the financial record analysis system 101 determines a dataset of historical financial record or invoice data related to a set of entities associated with at least one common attribute/identifier. The historical financial record data comprises an actual payment date or an indication of voiding for each of a plurality of invoices associated with one or more entities of the set of entities. For example, the dataset of historical financial record data may comprise an actual payment date attribute for each of a plurality of invoices. In situations where the invoice was not paid within a given period of time, the actual payment date for that respective invoice may be zero, or blank. Where the invoice has been paid, the value of the actual payment date attribute for that invoice is the date of payment of the respective invoice. For example, each of the plurality of invoices may be addressed or issued to at least one of the entities of the set of entities. In some embodiments, the plurality of invoices may be issued by at least one or more issuers. Accordingly, the historical financial record data of the dataset may relate to invoices issued to a single entity by a particular issuer, invoices issued to a single entity by multiple different issuers, invoices issued to a multiple entities by a particular issuer, or invoices issued to multiple entities by multiple different issuers. The dataset of historical invoice data may be extracted from historical financial record data 121 in memory 120 of the accounting system 118, in some embodiments. Alternatively, the dataset of historical invoice data may be extracted from an external database (not shown) or a third party database (not shown) accessible to the financial record analysis system 101.

The attributes associated with an invoice may include: an invoice date or an invoice issue date, an invoice amount, an invoice issuer entity identifier, an invoice addressee or counterparty entity identifier, an invoice due date, an invoice terms data, an invoice settlement or payment date data, for example. In some embodiments, the historical invoice data may be determined in response to a request from the computing device 112 for financial record analysis with respect to an invoice addressee or counterparty entity (first entity) identified in the request (first entity identifier), and may, for example, be a request for financial record analysis of the first entity with respect to any invoice issuer, or may be a request for financial record analysis of the first entity with respect to a particular party, for example, an issuer entity or a requesting entity, which may also be the requesting party.

At 204, the financial record analysis system 101 determines a first model 105 of payment behaviour of the entity set and a second model 106 of payment behaviour of the entity set. The first model 105 and the second model 106 are both configured to predict a date of payment of an invoice associated with the entity set identifier. The first and second models 105, 106 are different from each other.

The first and/or second models 105, 106 may comprise program code defining mathematical, statistical or machine learning operations to infer the invoice payment behaviour of the entity set. In some embodiments, the determined first and second models 105, 106 may receive as input, invoice data relating to a candidate invoice associated with an entity of the entity set, which may be a currently unpaid invoice, and determine a most probable payment date. In some embodiments, the determined first and second models 105, 106 may receive as input, invoice data relating to a candidate invoice, which may be a currently unpaid invoice, and determine a number of days till the expected payment. The number of days till the expected payment may be with respect to a current date, or an invoice issue date or an invoice due date, for example.

In some embodiments, one or both of the first and second models 105, 106 may be a univariate model 106. Univariate models 106 are arranged to receive a single input parameter related to a candidate invoice, and to predict when that candidate invoice is likely to be paid by an entity. Examples of univariate models include: (i) a model configured to receive as an input an issue date or due date of an invoice, and to determine a next business day (Monday to Friday) after the issue date or due date as the predicted date of when payment will be made; (ii) a model configured to receive as an input an issue date or due date of an invoice, and to determine a next day of the week after the issue date or due date as the predicted date of when payment will be made; (iii) a model configured to receive as an input an issue date or due date of an invoice, and to determine a particular day of the week after the issue date or due date as the predicted date of when payment will be made; (iv) a model configured to receive as an input an issue date or due date of an invoice, and to determine a particular business day of the week after the issue date or due date as the predicted date of when payment will be made; (v) a model configured to receive as an input an issue date or due date of an invoice, and to determine a particular date of the month after the issue date or due date as the predicted date of when payment will be made (for example, the 15^{th} of the month after the issue date or due date—so, if the issue or due date is the 17^{th} March, the predicted date would be the 17^{th} April); (vi) a model configured to receive as an input an issue date or due date of an invoice, and to determine a particular day of the month after the issue date or due date as the predicted date of when payment will be made (for example, the last Tuesday of the Month); and (vii) a model configured to receive as an input an issue date or due date of an invoice, and to determine the predicted date of when payment will be made as being a particular number of days after the issue date or due date. In some embodiments, payment date patterns, such as calendar day or date of the month, business days, non-business days, and/or specific days or dates of the month (such as the 1^{st} Monday of the month, or the 2nd Friday of the month) may be encoded as numbers. The univariate models 106 may provide such encoded numbers as outputs, and these may be converted or translated into specific days and/or dates, for example, using Python libraries.

In some embodiments, the univariate model(s) 106 may be based on a previous pattern(s) of payment behaviour identified from the dataset of historical invoice data associated with the entity set. For example, an average number of days after the issue date or due date of the invoices that it took for the entity to pay the plurality of invoices associated with the historical financial data in the dataset may be determined and this average number of days may be used as the particular number of days after the issue date or due date for the example model identified above at (vii). Similarly, the particular day of the week (for the model of (iii)), the particular business day of the week (for the model of (iv)), the particular date of the month (for the model of (v)), and/or the particular day of the month (for the model of (vii)), may be determined as being the most common day or date when payment was made by the entity for the plurality of invoices associated with the historical financial data in the dataset. Accordingly, the identified pattern indicative of payment on a specific day of the week (for example, payment every Friday), or a specific day of a month (for example, payment every last day of the month), or a specific business day (payment every Monday), or a specific day or a specific week of a month (for example, payment every second Monday of a month), for example. Each univariate model 106 may be based on a specific identified payment pattern derived from the dataset of historical invoice data, and based on the identified payment pattern, the univariate model may determine an expected payment date or number of days to an expected payment with respect to a candidate invoice.

In some embodiments, one or both of the first and second models 105, 106 may be a multivariate model. A multivariate model is a model that takes into account more than one variable in determining invoice payment behaviour. In other words, the multivariate model, takes as an input, a plurality of variables or feature values associated with a candidate invoice issued to an entity of the entity set and/or the financial history of the entity, and provides as an output, an indication of when the candidate invoice will be paid (for example, in terms of a specific day or day, or a number of days until it will be paid). The variables of feature values may be derived from the candidate invoice itself and/or account information associated with the entity, as for example, may be derived or determined from the accounting system 118, and/or associated database. The account information associated with the entity may comprise invoice payment history. The multivariate model may be based on a random forest regressor, in some embodiments.

In some embodiments, the first and/or second models may take into account any one or more of the metrics below which may be determined based on the dataset of historical invoice data, or on other financial data associated with the entity of the entity set:
Issue date and/or due date of candidate invoice.
Total invoice history: a total currency amount of all the invoices issued to the entity, and in some embodiments, issued to the entity by a particular issuing entity.
Total outstanding amount: a total currency amount of invoices not paid by the entity by a particular point in time, such as by a due date or an extended due date. For example, the particular point in time may be within 30 days of the issue date, or within 90 days of the issue date or by the time of execution of method 200 described below.
Invoice amount mean: an average currency amount of all, or a subset, of invoices directed or issued to the entity.
Amount of candidate invoice: a currency amount associated with a candidate invoice for which the multivariate model is to predict an expected payment day or date.
Outstanding invoices: a total number of invoices issued to or directed to the entity that have not been paid by the entity by a particular point in time, such as by a due date or an extended due date. For example, the particular point in time may be within 30 days of the issue date, or 90 30 days of the issue date or by the time of execution of method 200 described below.
Historic total invoice amount paid: a total currency amount of invoices paid by the entity, and in some embodiments, specifically in relation to invoices issued by the issuing entity.
Invoice number in last X months: a total number of invoices issued or directed to the entity over a particular period of time, such as the last 12 months from a particular point in time, which may be the time of execution of method 200. In some embodiments, the invoice number of the last 3 months, 6 months, 9 months, 15 months, 18 month and/or 24 months may be used as metric(s).
Candidate invoice to average invoice amount ratio: a ratio of the amount of the candidate invoice to the average invoice amount. The average invoice amount may be calculated over a particular period of time, such as the last 3 months, 6 months, 9 months, 12 months, 15 months, 18 month or 24 months, for example.
Candidate invoice to unpaid invoice amount ratio: a ratio of the amount of the candidate invoice and the total amount of unpaid invoices by a particular point in time, for example, the time of execution of method 200.
Minimum days old invoices: a number of days a most recently received invoice (with the exception of the candidate invoice) has remained due or unpaid.

In some embodiments, the multivariate model for predicting when an invoice will be paid, for example, the second model 106, comprises a first sub-model 106A trained using data associated with a first set of example invoices from the dataset of historical invoice data and a second sub-model 106B trained using data associated with a second set of example invoices from the dataset of historical invoice. The first set of example invoices may be invoices that were paid before or on the due date. The second set of invoices may be invoices that were paid on or after the due date.

The first sub model 106A is configured to predict when an invoice that is due but not yet overdue (or late), will be paid. Accordingly, when training the first sub model 106A the first set of example invoices were used. The second sub model 106B is configured to predict when an invoice that is overdue (or late), will be paid. Accordingly, when training the second sub model 106B, the second set of example invoices were used.

Accordingly, in embodiments where the first and/or second model 105, 106 comprises first and second sub models 105A and 105B, 106A and 106B, the first and/or second model 105, 106 may be first configured to determine whether a due date of a candidate invoice corresponds with the current calendar date (as may be provided to the model) or occurs before or after the current calendar date. If the due date occurs after the current calendar date (i.e., the candidate invoice is not yet overdue), the first sub model 105A, 106A may be selected to determine or predict when the candidate invoice is likely to be paid. If the due date occurs before the current calendar date (i.e., the candidate invoice is overdue), the second sub model 105B, 106B may be selected to determine or predict when the candidate invoice is likely to be paid. If the due date corresponds to the current calendar date, in some embodiments, the candidate invoice is not yet considered overdue, and the first sub model 105A, 106A may be selected to determine or predict when the candidate invoice is likely to be paid. In other embodiments, if the due date corresponds to the current calendar date the candidate invoice is considered overdue, and the second sub model 105B, 106B may be selected to determine or predict when the candidate invoice is likely to be paid.

In embodiments where the first sub model 105A, 106A is selected, a first feature set is provided to the first sub model 105A, 106A. In embodiments where the second sub model 105B, 106B is selected, a second feature set is provided to the second sub model 105B, 106B. The first feature set and the second feature set may correspond with one another, or may overlap with one another, or one of the feature sets may be a subset of the other feature set.

In some embodiments, the first feature set may comprise one or more of: (i) a difference between the due date of the candidate invoice and the current date (due_vs_now), (ii) a total number of outstanding or unpaid invoices associated with the set of entities to which the entity of the candidate invoice belongs (invoicesOutstandingCount), (iii) total amount of the candidate invoice (inv_total), (iv) total amount of the invoices associated with the set of entities to which the entity of the candidate invoice belongs (invoicesHistoryTotalAmount), (v) total amount of outstanding invoices associated with the set of entities to which the entity of the candidate invoice belongs (invoicesOutstandingTotalAmount), (vi) count of number of invoices, for example in the last 12 months, associated with the set of entities to which the entity of the candidate invoice belongs (cont_num_inv_12m), (vii) a minimum number of days old for invoices associated with the set of entities to which the entity of the candidate invoice belongs, which may be derived from a date of issuance of the invoice (cont_min_days_old), (viii) the invoice amount divided by a mean of the total invoice amount, for example, in the last year, associated with the set of entities to which the entity of the candidate invoice belongs (amount_vs_cmean), and (ix) a total number of invoices associated with the set of entities to which the entity of the candidate invoice belongs (invoiceHistoryCount).

In some embodiments, the second feature set may comprises one or more of: (i) a difference between due date of the candidate invoice and the current date (due_vs_now), (ii) a total number of outstanding invoices associated with the set of entities to which the entity of the candidate invoice belongs (invoicesOutstandingCount), (iii) total amount of outstanding invoices associated with the set of entities to which the entity of the candidate invoice belongs (invoicesOutstandingTotalAmount), and (iv) a count of the number of invoices, for example in the last 12 months, associated with the set of entities to which the entity of the candidate invoice belongs (cont_num_inv_12m).

In some embodiments, the financial record analysis system 101 determines a third model 107 of payment behaviour of the first entity. The third model 107 (non-payment estimation model) may be configured to predict a probability of non-payment or voiding of a candidate invoice associated with the first entity identifier. The non-payment estimation model 107 may comprise a multivariate model. In other words, the third model 107, takes as inputs, a plurality of variables or feature values associated with a candidate invoice issued to an entity of the entity set and/or the financial history (account information such as invoice payment history) of the entity, and provides as an output, an indication of the probability of non-payment of the candidate invoice. In some embodiments, the third model 107 for predicting non-payment or voiding of a current invoice may be based on logistic regression with a weight of evidence approach. The third model 107 for predicting non-payment or voiding of a current invoice may be based on a random forest classifier, in some embodiments.

In some embodiments, the third model 107 may take into account any one or more of the metrics below which may be determined based on the dataset of historical invoice data, or on other financial data associated with the entity set.
Issue date and/or due date of candidate invoice.
Number of voided invoices by the entity: a total number of invoices that have been voided for non-payment.
Total amount of voided invoices by the entity: a total currency amount associated with the voided invoices.
Average day of the month: an average number of a 30 days scale on which payment was received for invoices of the entity.
Paid invoices by the entity: a total amount of invoices paid over a particular period, for example, over the last 3, months, 6 months, 9 months, 12 months, 15 months, 18 month or 24 months
Candidate invoice to average invoice amount ratio of the entity: a ratio of the amount of the candidate invoice to the average invoice amount. The average invoice amount may be calculated over a particular period of time, such as the last 3, months, 6 months, 9 months, 12 months, 15 months, 18 month or 24 months, for example.
Business day of the month of the issue date and/or the business day of the month of the due date.

In some embodiments, the invoice data in the dataset of historical financial data associated with the entity set relates to one or more issuing entities. In some embodiments, the invoice data may be filtered by issuing entities, and only the invoice data relating to a particular issuing entity be used to determine or configure the first, second, and/or third models. Accordingly, the first, second and/or third models 105, 106, 107 may be configured to infer the payment behaviour of the first entity with respect to a specific invoice issuing party or entity, or with respect to multiple issuing parties. Similarly, the invoice data in the dataset of historical financial data associated with the entity set may relate to one or more entities (invoice addressees), and the invoice data may be filtered by invoice addressees. Similarly, the invoice data may be filtered by any other attribute, such as business stage, business type, typical turnover, geography/location etc., to configure the first, second and/or third models to infer the payment behaviour of a select group of entities having one or more common attribute(s).

At 206, the financial record analysis system 101 determines a first predicted payment date for each of the plurality of invoices associated with the dataset of historical financial record data using the first model and a second predicted payment date for each of the plurality of invoices associated with the dataset of historical financial record data using the second model.

In some embodiments, the financial record analysis system 101 determines a probability score of non-payment of each of the plurality of invoices associated with the dataset of historical financial record data using the third model 107.

The dataset of historical invoice data also comprises an actual payment date data associated with each invoice if a payment has been received. At 208, the financial record analysis system 101 determines a first error metric and a second metric associated with the first model and the second model, 105, 106 respectively. The first and second error metrics may be based on the actual payment date data associated with each invoice in the dataset of historical invoice data. For example, the first and second error metrics may be based on respective differences between the predicted first and second predicted payment dates and the actual payment date for each of the plurality of invoices. The difference may be quantified using one or more statistical measures such as an average, a combination of an average and a standard deviation or a histogram of the error number and frequency, for example. The same error metric quantification technique is used to determine the first and second error metrics to allow comparison and evaluation of the performance of the first and second model.

In some embodiments, the financial record analysis system 101 determines a third error metric associated with the third model 107. The third error metric is indicative of the accuracy of the probability score relative to whether or not the invoice was paid.

At 210, the financial record analysis system 101 selects a designated prediction model for the first entity from a set of prediction models based on corresponding error metrics of the respective prediction models. The set of prediction models comprises at least the first model 105 and the second model 106. In some embodiments, the set of prediction models further comprises the third model 107. Accordingly, for example, in some embodiments, the financial record analysis system 101 may determine one of the first, second and third models 105, 106, 107 as the designated prediction model for predicting invoice behaviour of the entity set (which may include a single entity), or as the designated prediction model for predicting invoice behaviour of the entity set with respect to a group of or a particular issuing entity. The financial record analysis system 101 may be configured to select a prediction model from the set of prediction models that has the lowest error metric.

At 212, the financial record analysis system 101 deploys the designated prediction model for predicting invoice payment dates for invoices issued to an entity of the entity set, or in some embodiments, for predicting invoice payment dates for invoices issued to an entity of the entity set by a particular issuing entity.

In some embodiments, method 200 may further comprise updating the historical financial record data of the entity set by adding or including new data associated with financial records of the entity set, for example, as they are processed by the accounting system 118. For example, once an invoice is paid, or a period of time has expired without the invoice being paid (in which case it may be deemed void), data associated with the invoice may be added to the historical financial record data.

Method 200 may be performed dynamically, for example, in response to a change in content of the historical financial record data, periodically, once a threshold amount of new data is added to the historical financial record data of the entity set, and/or in response to a request from a user or application, such as a cash flow forecasting application (not shown) which may be deployed on the accounting system 118, for example. Applicant's International Patent Application Nos. PCT/AU2020/050924 and PCT/AU2020/051184 disclose a forecasting application with which the disclosed embodiments may be used, the entire content of both of which is incorporated herein by reference.

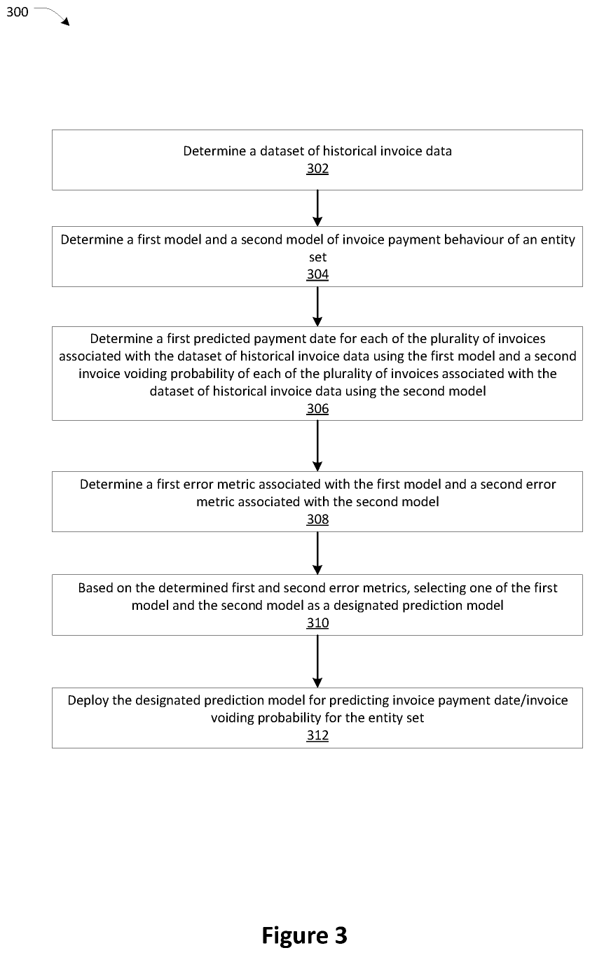

FIG. 3 is a process flow diagram of a method 300 of determining payment behaviour of an entity, according to some embodiments. The method 300 may, for example, be implemented by the processor(s) 102 of the financial record analysis system 101 executing instructions stored in memory 103.

At 302, the financial record analysis system 101 determines a dataset of historical invoice data related to a set of entities (entity set) associated with at least one common attribute/identifier. For example, the common attribute(s) may be a business stage (such as a start-up business), a business type (such as an electricity provider), a typical turnover, and/or location of the entity. In some embodiments, the set of entities comprises a single entity. The dataset of historical financial record data may correspond with that described above with reference to FIG. 2.

At 304, the financial record analysis system 101 determines a first model 105 of payment behaviour of the first entity and a second model (non-payment estimation model) 106 of payment behaviour of the first entity. The first model 105 may be configured in the same manner as the first model 105 described above with reference to the process of FIG. 2. The second model 106 may be configured in the same manner as the third model 107 described above with reference to the process of FIG. 2. In particular, the first model 105 may be configured to predict a date of payment of an invoice associated with an entity of the entity set. The second model 106 may be configured to predict a probability of an invoice associated with an entity of the entity set being voided or a probability of non-payment of an invoice. The first and second models are different from each other.

In some embodiments, the first model 105 may comprise a first sub-model 105A configured to predict a date of payment of an invoice associated with an entity of the entity set where the due date of the invoice has not yet occurred (the invoice is not overdue) and a second sub-model 105B configured to predict a date of payment of an invoice associated with an entity of the entity set where the due date of the invoice has passed (the invoice is overdue). In some embodiments, the first model 105 is configured to determine whether or not a candidate invoice is overdue, for example by comparing a current date with the due date of the candidate invoice. If the invoice is not yet overdue, the first model 105 may elect to use the first sub-model 105A to predict the date of payment of the candidate invoice. On the other hand, if invoice is overdue, the first model 105 may elect to use the second sub-model 105B to predict the date of payment of the candidate invoice.

At 306, the financial record analysis system 101 determines a first predicted payment date for each of the plurality of invoices associated with the dataset of historical invoice data using the first model 105 and a second invoice voiding probability of each of the plurality of invoices associated with the dataset of historical invoice data using the second model 106.

At 306, the financial record analysis system 101 determines a first error metric and a second error metric associated with the first model 105 and the second (non-payment estimation) model 106, respectively. In some embodiments, this may be performed in accordance with the methods described above in respect of determining the first error metric and the third error metric respectively.

At 310, the financial record analysis system 101 selects a designated prediction model for the entity set from a set of prediction models based on corresponding error metrics of the respective prediction models. The set of prediction models comprises at least the first model 105 and the second (non-payment estimation) model 106. Accordingly, for example, in some embodiments, the financial record analysis system 101 may determine the first or second model as the designated prediction model for predicting invoice behaviour of the entity set (which may include a single entity), or as the designated prediction model for predicting invoice behaviour of the entity set with respect to a group of issuing entities or a particular issuing entity. The financial record analysis system 101 may be configured to select a prediction model from the set of prediction models that has the lowest error metric.

At 310, the financial record analysis system 101 deploys the designated prediction model for predicting payment behaviour for entities of the entity set. The designated prediction model may predict invoice payment dates for invoices or predict invoice voiding probability for invoices, depending on which of the first or second model was selected as the designated model. In some embodiments, the designated model may be deployed on the financial record analysis system 101 and/or on the accounting system 118 to be accessible for interaction by the computing device 112. In some embodiments, the predicted invoice payment dates by the designated prediction model may be transmitted to the computing device 112 and displayed on the user interface 113.

In some embodiments, method 300 may further comprise updating the historical financial record data of the entity set by adding or including new data associated with financial records of the entity set, for example, as they are processed by the accounting system 118. For example, once an invoice is paid, or a period of time has expired without the invoice being paid (in which case it may be deemed void), data associated with the invoice may be added to the historical financial record data.

Method 300 may be performed dynamically, for example, in response to a change in content of the historical financial record data, periodically, once a threshold amount of new data is added to the historical financial record data of the entity set, and/or in response to a request from a user or application, such as a cash flow forecasting application (not shown) which may be deployed on the accounting system 118, for example.

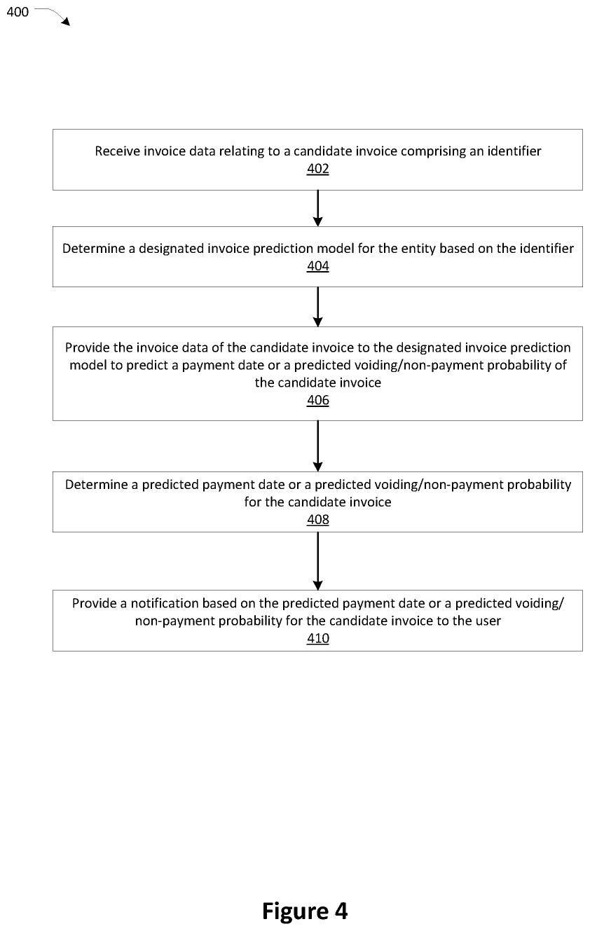

FIG. 4 is a process flow diagram of a method 400 of determining a predicted payment date for a candidate invoice, according to some embodiments. The method 400 may, for example, be implemented by the processor(s) 102 of the financial record analysis system 101 executing instructions stored in memory 103.

At 402, the accounting system 118 receives invoice data relating to a candidate invoice, the invoice data comprising a first identifier. The first identifier may be an entity identifier, or any other attribute identifier, such as an identifier of business stage, business type, typical turnover, geography/location etc.

At 404, the accounting system 118 determines a designated invoice prediction model for the entity based on the identifier. In some embodiments, the accounting system 118 determines a suitable designated invoice prediction model by performing method 200 or method 300, or transmitting a request to the financial record analysis system 101 to perform methods 200 or method 300. In some embodiments, the designated invoice prediction model for the entity has been previously selected and deployed on accounting system 118.

At 406, the accounting system 118 provides the invoice data of the candidate invoice to the designated invoice prediction model to predict a payment date or a predicted voiding/non-payment probability of the candidate invoice. The invoice data may comprise one or more attributes associated with the invoice including: an invoice issue date, an invoice due date, an invoice amount, an invoice issuer identifier, and/or an invoice address identifier.

At 408, the accounting system 118 determines a predicted payment date or a predicted voiding/non-payment probability for the candidate invoice from the output of the designated invoice prediction model. At 410, the accounting system 118 may provide the predicted payment date or the predicted voiding/non-payment probability for the candidate invoice, or a notification based thereon, to the user, for example, by presenting the information on a screen of the user interface 113 of the computing device 112.

As indicated above, the multivariate model(s) and the voiding model may be trained using a database of historical invoice data and entity metrics. This information may be accessible to an accounting platform, such as system 118, configured to maintain bookkeeping accounts for a plurality of entities or organisations.

In one example, a multivariate model was trained to predict invoice payment behaviour of an entity based on a database of information about 2008 entities, and included 45,062 example invoices. Of these invoices, some had not been paid at the time of training and were still outstanding. The untrained multivariate model comprised two sub models. The sub models were random forest regressors. The first sub model was trained to predict payment dates of invoices which were due, but not overdue, and was trained using data associated with invoices that were paid by or on the due date. The second sub model was trained to predict payment dates of invoices which were already overdue, and was trained using data associated with invoices that were paid after the due date.

For the first sub model, for each example invoice, the following features were provided as inputs to the random forest regressor: (i) a difference between the due date of the candidate invoice and the current date (due_vs_now), (ii) a total number of outstanding or unpaid invoices associated with the set of entities to which the entity of the candidate invoice belongs (invoicesOutstandingCount), (iii) total amount of outstanding invoices associated with the set of entities to which the entity of the candidate invoice belongs (invoicesOutstandingTotalAmount), and (iv) count of number of invoices, for example in the last 12 months, associated with the set of entities to which the entity of the candidate invoice belongs (cont_num_inv_12m), with the actual payment day of each invoice being the target.

For the second sub model, for each example invoice, the following features were provided as inputs to the random forest regressor: (i) a difference between the due date of the candidate invoice and the current date (due_vs_now), (ii) a total number of outstanding or unpaid invoices associated with the set of entities to which the entity of the candidate invoice belongs (invoicesOutstandingCount), (iii) total amount of the candidate invoice (inv_total), (iv) total amount of the invoices associated with the set of entities to which the entity of the candidate invoice belongs (invoicesHistoryTotalAmount), (v) total amount of outstanding invoices associated with the set of entities to which the entity of the candidate invoice belongs (invoicesOutstandingTotalAmount), (vi) the invoice amount divided by a mean of the total invoice amount, for example, in the last year, associated with the set of entities to which the entity of the candidate invoice belongs (amount_vs_mean), (vii) invoicesOutstandingTotalAmount, (viii) count of number of invoices, for example in the last 12 months, associated with the set of entities to which the entity of the candidate invoice belongs (cont_num_inv_12m), (ix) a minimum number of days old for invoices associated with the set of entities to which the entity of the candidate invoice belongs, which may be derived from a date of issuance of the invoice, which may be derived from a date of issuance of the invoice (cont_min_days_old), (x) the invoice amount divided by a mean of the total invoice amount, for example, in the last year, associated with the set of entities to which the entity of the candidate invoice belongs (amount_vs_cmean), (xi) a total number of invoices associated with the set of entities to which the entity of the candidate invoice belongs (invoiceHistoryCount), with the actual payment day of each invoice being the target.

In another example, a multivariate model was trained to predict invoice payment behaviour of an entity based on a database of information about 2008 entities, and included 45,062 example invoices. Of these invoices, some had not been paid at the time of training and were still outstanding. The untrained multivariate model was a random forest classifier. For each example invoice, the following features were provided as inputs to the random forest regressor: (i) over the last 3 months, the number of invoices with a day of the month, which may be a count of all of the example invoices assuming each invoice has a date associated with it(M3_dayofmonth_n), (ii) over the last 24 months, the mean of the encoded payment date pattern numbers for the entity associated with the invoice (M24_dayplace_mean), (iii) over the last 3 months, the number of invoices having a date that is a day of business month, i.e. a date that corresponds with a week day (Monday to Friday) (M3_dayofbusmonth_n) (iv) count of number of invoices that have dates within the last 12 months (cont_num_inv_12m), (v) in the last 3 months, the number of invoices with an encoded payment date pattern number (M3_dayplace_n), (vi) over the last 24 months, the number of invoices having a date that is a business day of the month(M24_dayofbusmonth_n), (vii) a number of invoices that have been paid within a given period by the entity set, for example, in the last 3 months (M3_paidinv_n), (viii) an average of paid date to invoice date for the entity set for a given period of time, such as 24 months (M24_paidinv_mean), (ix) average days difference between fully paid on date and the due date for the entity set over a period of time, such as the last 3 months (C3_fpaid_vs_due), (x) amount divided by invoice history total amount (amount_pct), with the actual payment day of each invoice being the target. As a result of the training, the trained multivariate model was configured to predict non-payment or voiding of a candidate invoice.

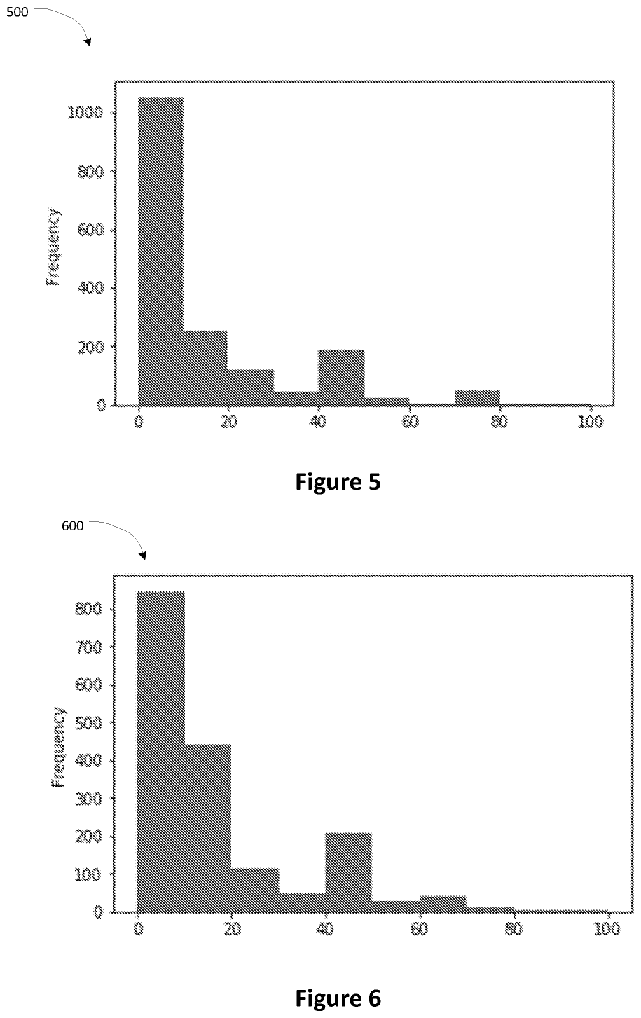

A worked example of the application of the method 200 is now described with reference to FIGS. 5, 6, 7, 8, 9 and 10. FIGS. 5, 6, 7, 8, 9 and 10 illustrate histograms of determined error metrics of models in predicting payment behaviour of an entity when executed on a dataset comprising data relating to 9745 invoices issued by 100 issuer entities. The x-axis of each of the FIGS. 5, 6, 7, 8, 9 and 10 relates to an error in the number of days prediction of invoice payment dates. The y-axis of each of the FIGS. 5, 6, 7, 8, 9 and 10 relates to a frequency or number of invoices in the dataset of historical invoice data that are associated with a particular error value on the x-axis.

FIG. 5 illustrates a histogram 500 where the error values on the x-axis are based on predicted invoice payment dates based on a univariate model determining the number of days till payment of an invoice based on an average number of days till payment with respect to the invoice issue date, the average number of days till payment being calculated based on the historical financial record data 121.

FIG. 6 illustrates a histogram 600 where the error values on the x-axis are based on predicted invoice payment dates based on a day of the week variable by a univariate model, wherein the predicted invoice payment date is determined with reference to an invoice issue date.

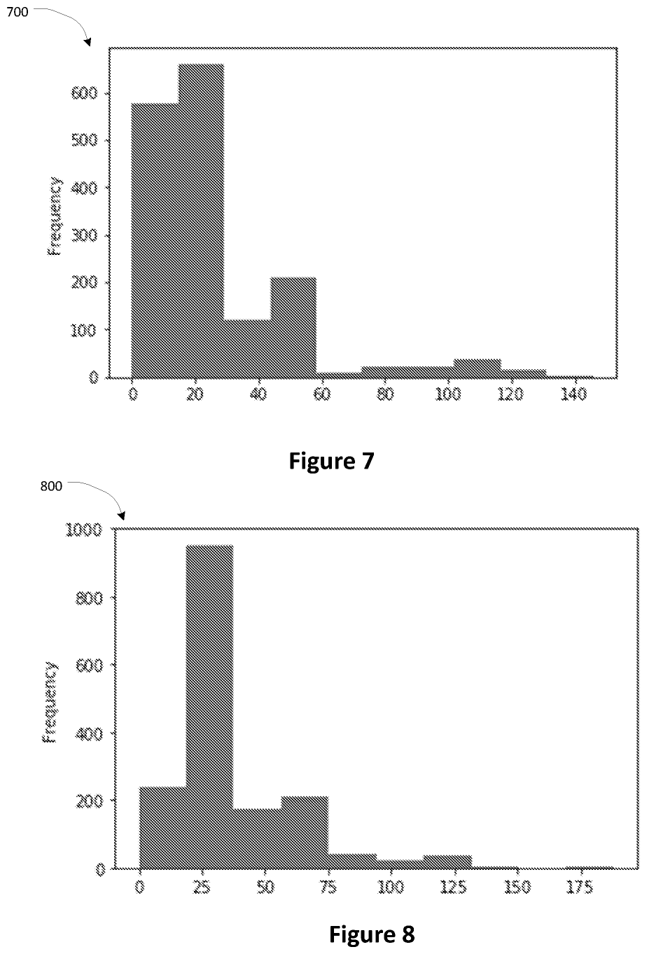

FIG. 7 illustrates a histogram 700 where the error values on the x-axis are based on predicted invoice payment dates based on a business day's variable used by a univariate model, wherein the predicted invoice payment date is determined with reference to an invoice issue date.

FIG. 8 illustrates a histogram 800 where the error values on the x-axis are based on predicted invoice payment dates based on a univariate model determining the number of days till payment of an invoice based on an average number of days till payment with respect to the invoice due date, the average number of days till payment being calculated based on the historical financial record data 121.

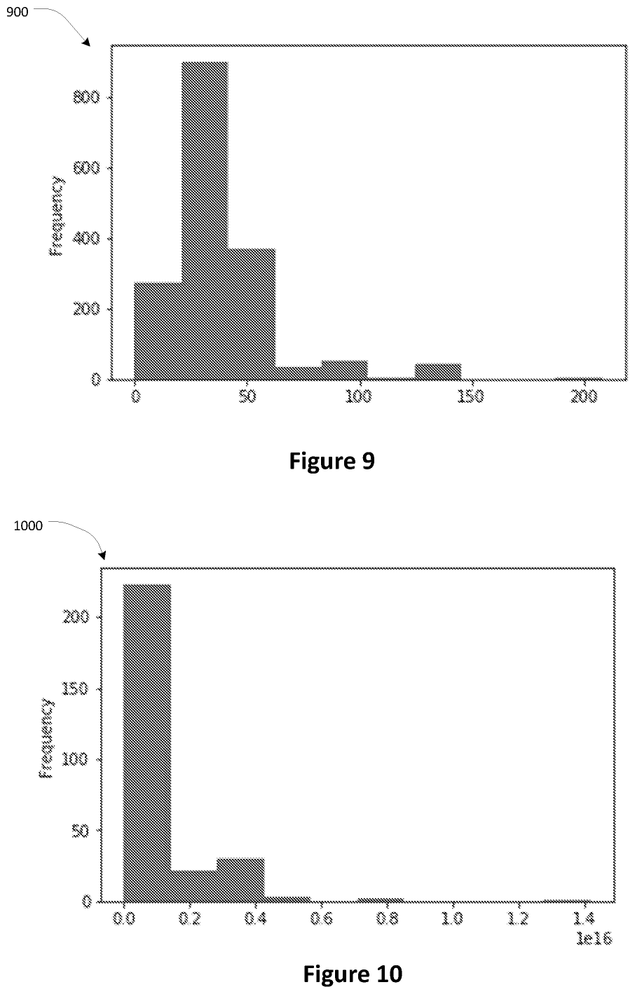

FIG. 9 illustrates a histogram 900 where the error values on the x-axis are based on predicted invoice payment dates based on a day of the week variable by a univariate model, wherein the predicted invoice payment date is determined with reference to an invoice due date.

FIG. 10 illustrates a histogram 1000 where the error values on the x-axis are based on predicted invoice payment dates based on a business days variable used by a univariate model, wherein the predicted invoice payment date is determined with reference to an invoice due date.

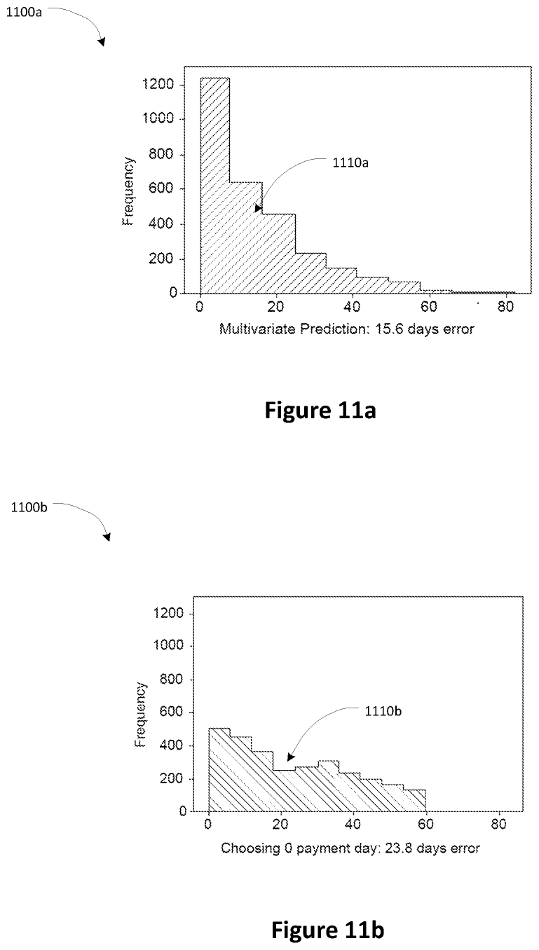

FIG. 11a and FIG. 11b illustrates a charts or plots 1100a and 1100b which can be used to compare an error associated with the prediction of payment date by the multivariate model (FIG. 11a) and an assumption that the payment will be made on the due date (an assumption that the predicted payment date is 0—FIG. 11b). The x-axis of each of the charts 1100a and 1100b relate to an error in the number of days is prediction of invoice payment dates. The y-axis of charts 1100a and 1100b relate to a frequency or number of invoices in the dataset of historical invoice data that are associated with a particular error value on the x-axis.

The shaded portion 1110a of the chart 1100a relates to an error associated with predictions of the multivariate model in this example. The shaded portion 1110b of the chart 1100b relates to an error associated with an assumption that the predicted payment date is 0. As is observable from charts 1100a and 110b, use of the multivariate model concentrates the error to a lower number compared with the assumption that all invoices are paid on the due date, in this example. In other words, in this example, the shaded portion 1110a corresponds to an average of 15.7 days error whereas the shaded portion 1110b corresponds to an average 23.8 days error.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A method comprising:
determining a dataset of historical financial record data related to an entity set, the entity set comprising one or more entities having a common attribute, and wherein the historical financial record data comprises an actual payment date or an indication of voiding for each of a plurality of invoices associated with one or more entities of the entity set;
determining a first model of payment behaviour of the entity set, the first model configured to predict a date of payment of an invoice by an entity;
determining a second model of payment behaviour of the entity set, the second model configured to predict a date of payment of an invoice by the entity, and the second model being different to the first model;
determining a first predicted payment date for each of the plurality of invoices associated with the dataset of historical financial record data using the first model;
determining a second predicted payment date for each of the plurality of invoices associated with the dataset of historical financial record data using the second model;
determining a first error metric associated with the first model, wherein the first error metric is based on a first difference measure between the actual payment date and the predicted first payment date for each of the plurality of invoices;
determining a second error metric associated with the second model, wherein the second error metric is based on a second difference measure between the actual payment date and the predicted second payment date for each of the plurality of invoices;
selecting a designated prediction model from a set of prediction models based on corresponding error metrics of the respective prediction models, the set comprising at least the first model and the second model; and
deploying the designated prediction model for predicting payment behaviour for the entity set.

2. The method of claim 1, wherein the plurality of invoices are invoices issued by (i) a particular issuing entity or (ii) a group of issuing entities having a common attribute.

3. The method of claim 1, wherein each of the plurality of invoices are associated with a same first entity as an invoice addressee.

4. The method of claim 1, wherein at least the first model of the first and second models is a univariate model, and wherein the dataset of historical financial record data further comprises an issue date and/or a due date of each of the plurality of invoices associated with the dataset.

5. The method of claim 4, wherein the univariate model predicts invoice payment dates for a first entity as being any one of:
(i) a particular number of days after the issue date or the due date;
(ii) a particular date of a month of the issue date or due date;
(iii) a next day of a week after the issue date or due date;
(iv) a next business day of the week after the issue date or the due date;
(v) a predefined day of a predefined week of a month after the issue date or the due date; and
(vi) a specific number of days after the issue date or the due date.

6. The method of claim 1, wherein at least the second model is a multivariate model, and the method further comprises:
determining values for a plurality of first feature for each of the respective plurality of invoices associated with the dataset; and
providing, as an input to the multivariate model, the values of the plurality of first feature associated with the plurality of invoices; and
predicting, as an output, a second payment date for the plurality of invoices.

7. The method of claim 6, wherein the second model comprises a first sub model configured to predict an invoice payment date for an invoice that is not overdue.

8. The method of claim 6, wherein the second model comprises a second sub model configured to predict an invoice payment date for an invoice that is overdue.

9. The method of claim 8, wherein the first features provided to a first sub model are different to, or the same as, the first features provided to the second sub model.

10. The method of claim 6, wherein the values for the plurality of first features are derived from a respective invoice and/or accounting information associated with an entity addressee of the respective invoice.

11. The method of claim 6, wherein the multivariate model is implemented using a random forest regression model.

12. The method of claim 1, further comprising:
determining a third model of payment behaviour of the entity set, the third model configured to predict a probability of non-payment of an invoice associated with the entity set; and
determining a probability score of non-payment of each of the plurality of invoices associated with the dataset of historical financial record data using the third model;
determining a third error metric associated with the third model, wherein the third error metric is indicative of an accuracy of the probability score relative to whether or not the invoice was paid; and
wherein the set of prediction models from which the designated prediction model is selected comprises the third model.

13. The method of claim 12, further comprising:
determining values for a plurality of second features for each of the respective plurality of invoices associated with the dataset; and
providing, as an input to a multivariate model, the values of the plurality of second features associated with the plurality of invoices; and
predicting, as an output, the probability score of non-payment of each of the plurality of invoices.

14. The method of claim 13, wherein the values for the plurality of second features are derived from a respective invoice and/or accounting information associated with an entity addressee of the respective invoice.

15. The method of claim 12, wherein the third model is implemented using logistic regression or a random forest classifier.

16. (canceled)

17. (canceled)

18. (canceled)

19. (canceled)

20. (canceled)

21. A computing device comprising:
one or more processors; and
memory comprising computer executable instructions, which when executed by the one or more processors, cause the computing device to:
determine a dataset of historical financial record data related to an entity set, the entity set comprising one or more entities having a common attribute, and wherein the historical financial record data comprises an actual payment date or an indication of voiding for each of a plurality of invoices associated with one or more entities of the entity set;
determine a first model of payment behaviour of the entity set, the first model configured to predict a date of payment of an invoice by an entity;
determine a second model of payment behaviour of the entity set, the second model configured to predict a date of payment of an invoice by the entity, and the second model being different to the first model;
determine a first predicted payment date for each of the plurality of invoices associated with the dataset of historical financial record data using the first model;
determine a second predicted payment date for each of the plurality of invoices associated with the dataset of historical financial record data using the second model;
determine a first error metric associated with the first model, wherein the first error metric is based on a first difference measure between the actual payment date and the predicted first payment date for each of the plurality of invoices;
determine a second error metric associated with the second model, wherein the second error metric is based on a second difference measure between the actual payment date and the second predicted payment date for each of the plurality of invoices;
select a designated prediction model from a set of prediction models based on corresponding error metrics of the respective prediction models, the set comprising at least the first model and the second model; and
deploy the designated prediction model for predicting payment behaviour for the entity set.

22. A computer-readable storage medium storing instructions that, when executed by a computer, cause the computer to perform operations including:
determining a dataset of historical financial record data related to an entity set, the entity set comprising one or more entities having a common attribute, and wherein the historical financial record data comprises an actual payment date or an indication of voiding for each of a plurality of invoices associated with one or more entities of the entity set;
determining a first model of payment behaviour of the entity set, the first model configured to predict a date of payment of an invoice by an entity;
determining a second model of payment behaviour of the entity set, the second model configured to predict a date of payment of an invoice by the entity, and the second model being different to the first model;
determining a first predicted payment date for each of the plurality of invoices associated with the dataset of historical financial record data using the first model;
determining a second predicted payment date for each of the plurality of invoices associated with the dataset of historical financial record data using the second model;
determining a first error metric associated with the first model, wherein the first error metric is based on a first difference measure between the actual payment date and the predicted first payment date for each of the plurality of invoices;
determining a second error metric associated with the second model, wherein the second error metric is based on a second difference measure between the actual payment date and the second predicted payment date for each of the plurality of invoices;
selecting a designated prediction model from a set of prediction models based on corresponding error metrics of the respective prediction models, the set comprising at least the first model and the second model; and
deploying the designated prediction model for predicting payment behaviour for the entity set.

23. The computing device of claim 21, wherein at least the first model of the first and second models is a univariate model, and wherein the dataset of historical financial record data further comprises an issue date and/or a due date of each of the plurality of invoices associated with the dataset.

24. The computing device of claim 21, wherein at least the second model is a multivariate model, and wherein the computer executable instructions, when executed, cause the computing device to:
determine values for a plurality of first feature for each of the respective plurality of invoices associated with the dataset; and
provide, as an input to the multivariate model, the values of the plurality of first feature associated with the plurality of invoices; and
predict, as an output, a second payment date for the plurality of invoices.

25. The computing device of claim 21, wherein the computer executable instructions, when executed, cause the computing device to:
determine a third model of payment behaviour of the entity set, the third model configured to predict a probability of non-payment of an invoice associated with the entity set; and
determine a probability score of non-payment of each of the plurality of invoices associated with the dataset of historical financial record data using the third model;
determine a third error metric associated with the third model, wherein the third error metric is indicative of an accuracy of the probability score relative to whether or not the invoice was paid; and
wherein the set of prediction models from which the designated prediction model is selected comprises the third model.

26. The computer-readable storage medium of claim 22, wherein at least the first model of the first and second models is a univariate model, and wherein the dataset of historical financial record data further comprises an issue date and/or a due date of each of the plurality of invoices associated with the dataset.

27. The computer-readable storage medium of claim 22, wherein at least the second model is a multivariate model, and the operations further include:
determining values for a plurality of first feature for each of the respective plurality of invoices associated with the dataset; and
providing, as an input to the multivariate model, the values of the plurality of first feature associated with the plurality of invoices; and
predicting, as an output, a second payment date for the plurality of invoices.
